(19) United States
(12) Patent Application Publication
(10) Pub. No.: US 2002/0151319 A1
(43) Pub. Date: Oct. 17, 2002

(54) METHOD FOR CONTROLLING THE TRANSMISSION AND RECEPTION ACTIVITIES OF A LOCAL RADIOCOMMUNICATIONS SYSTEM

(76) Inventors: OLAF JOHANNES JOERESSEN, DUSSELDORF (DE); GREGOR SCHNEIDER, BOCHUM (DE)

Correspondence Address: CLARENCE A GREEN, PERMAN & GREEN, 425 POST ROAD, FAIRFIELD, CT, 06430

(21) Appl. No.: 09/190,422

(22) Filed: Nov. 12, 1998

(30) Foreign Application Priority Data
Nov. 18, 1997 (DE) 197 51 073.6

(51) Int. Cl. H04B 7/00

(52) U.S. Cl. 455/518; 455/519; 455/67.3

(57) ABSTRACT

The present invention relates to a method for controlling the transmission and reception activities of a local radiocommunications system having a main unit (MU) and at least one slave unit (SU). In the case of this local radiocommunications system, which operates at a low power level, in order to prevent mutual interference with an associated reference system, which operates at a relatively high power level, the invention provides that a timebase for communication with the slave unit or units (SU) is defined in the main unit (MU) as a function of the timebase of the reference system (12), and that the frame length (t_{Fr}) defined on the basis of the timebase is reported to each slave unit (SU).

The invention relates to a method for controlling the transmission and reception activities of a local radiocommunications system and, in particular, for controlling the transmission and reception activities of a digital radio-frequency radiocommunications system having a master or main unit and having one or more subordinate slave or terminal units, in which the radiocommunication between the main unit and the slave units is carried out at a low power level.

In such a system, radiocommunication from the main unit to the slave units is carried out using the time-division multiplex mode, while the reception and transmission activities of the slave units are carried out with a time delay. All the transmission and reception activities are in this case expediently included in a frame structure. A frame is in this case a time period having a specific length, which is subdivided into so-called timeslots in each of which an information packet, a so-called burst, is transmitted or received.

FIG. 1 shows, purely schematically, one example of a local radiocommunications system 10 having a main unit MU and a large number of slave units SU1, SU2, SU3. The main unit 10 is combined together with a terminal 11 of a cellular mobile radio system 12 in a handset HA of a mobile telephone, or in a car telephone. Problems can occur in this case if the terminal 11 communicates at a relatively high power level of, for example, 2 watts or more, via a corresponding channel 13 with a base station BS in the mobile radio system 12, and the main unit MU of the local radiocommunications system 10 at the same time has to interchange data and information, since the transmission and reception activities of the two systems interfere with one another if these activities are not matched to be successive in time.

If one remembers in this case that the local radiocommunications system has a range of not significantly more than ten meters and transmits, for example, with a power level of only one milliwatt, then problems can occur if information is being received in the local radiocommunications system while the terminal 11 is in the transmission mode, unless expensive hardware screening measures are provided.

Since the control programs for the two systems have to handle two different timescales in this case, the peak computation load on the overall unit in the handset HA is increased, since the computation activities of the two systems are shifted with respect to one another and can thus take place at the same time. In particular, a situation can arise in which activities actually have to be carried out at the same time in both systems, that is to say in the local radiocommunications system 10 and in the cellular mobile radio system 12 quoted by way of example here, so that, in this case, completely independent hardware devices, in particular interfaces, have to be made available, since one interface that is used for both systems cannot control both systems independently.

Owing to the lack of any time relationship between the activities, possible mutual interference involves expensive screens and circuit components in order nevertheless to satisfy the technical specifications, in particular the licensing regulations. Furthermore, the total power consumption must be taken into account if both the terminal 11 and the main unit MU in a handset HA are supplied from a common energy source. If a sleep mode is provided for both systems, in order to save energy, two different sleep cycles also have to be controlled, which results in the controller being active for a longer time than would be necessary in an individual system, so that the energy consumption is likewise increased as a result of this.

The invention is based on the object of providing a method for controlling the transmission and reception activities of a local radiocommunications system and which allows the relative timing of the communications activities to be flexibly matched to the respective requirements.

This object is achieved by the method according to claim 1.

The invention therefore provides that a timebase for communication with the slave units is in each case defined in the main unit, and the frame length defined on the basis of the timebase is reported to each slave unit. This makes it possible to vary the timebase required to define the respective frame times depending on the requirements, so that, particularly when the radiocommunications system according to the invention is used together with a further system, which is called the reference system in the following text and is, for example, a cellular mobile radio system, communication activity overlaps can easily be prevented.

It is particularly advantageous in this case if, in order to match the transmission and reception activities of the radiocommunications system to a reference system, the timebase of the local radiocommunications system is derived from the timebase of the reference system, in which case it is expediently provided that the main unit is allocated to a terminal of a reference system, and that the timebase of the main unit is correlated with the transmission activity of the terminal.

This makes it possible in a particularly reliable manner to preclude common activities by the local radiocommunications system and the reference system since, in the event of any change in the timebase or a shift in the transmission activities of the reference system, as can occur, for example, in a cellular system when a terminal changes from one cell to the next, the timebase in the local radiocommunications system is matched in a corresponding manner.

The time control can be carried out particularly easily if a frame time of the reference system is used as the timebase for the local radiocommunications system, and if the frame time for each slave unit is related to the timebase by an integer ratio. This also makes it possible to select different frame times for different slave units in the local radiocommunications system, so that a longer frame time can be provided for slave units with which only a relatively small amount of data has to be interchanged, while a short frame time is selected for a high data traffic level.

It is furthermore particularly advantageous if the frame time in each slave unit is in each case measured from the start of a received information packet, in which case each slave unit respectively changes at the end of a frame to the standby mode during normal communications operation, and then remains in the standby mode, either until it receives an information packet intended for it, or until a time specified for the maximum duration of the standby mode has elapsed.

In this way, the shifts in the timebase, such as those which can occur during the so-called handover in a cellular mobile radio system can be handled particularly easily, since if, as a consequence of a handover, the time interval between two successive transmission activities in the terminal becomes greater than the frame time, the slave unit in the local radiocommunications system just waits in the standby mode until it once again receives an information packet intended for it.

It is particularly advantageous in this case if the maximum standby mode time is not specified as a fixed value, but can be defined as a function of the frame time in the reference system.

In order to improve the reliability of communication between the main unit and the slave units in the local radiocommunications system, it is furthermore provided for an information item to be transmitted with each information packet, allowing the information packet to be allocated to the slave unit.

It is particularly advantageous if the reporting of the frame length, of the response time delay and of the maximum response duration is carried out by sending a message to all the associated slave units or by communication with each individual slave unit.

In order to keep the energy consumption as low as possible, it is provided that after completion of normal communications operation, a sleep mode is initiated, whose sleep interval corresponds to that of the terminal in the reference system. In this way, only a single sleep mode or a single sleep interval need be monitored, so that the energy consumption required for this corresponds essentially to that for monitoring the sleep mode in the individual system.

In order to make it possible to transmit both data streams at a constant data rate and data packets as reliably as possible and with little effort, the invention provides that each information packet has a data field of fixed length for control data and a data field of variable length for user or wanted data, the length information item for the variable-length data field being transmitted in the fixed-length data field and being protected by means of an error-correcting code which is transmitted in the fixed-length data field. The use of a variable-length data field for transmitting the wanted data results in the amount of energy consumed to transmit the respective burst or information packet being only as much as is absolutely necessary, since the respective transmitting unit transmits only for as long as is actually necessary, while the receiving unit can end the standby mode immediately after it has completely received the burst. In this case, the error-correcting code, which is transmitted in the fixed-length data field, ensures that the receiving end always identifies the length of the burst to be received.

In order further to improve the reliability of data transmission, it is possible to provide for other fields in the fixed-length data field as well to be protected by means of an error-correcting code transmitted in the fixed-length data field.

The invention will be explained in more detail in the following text by way of example with reference to the drawing, in which:

FIG. 1 shows a schematic block diagram of a local radiocommunications system combined with a reference system,

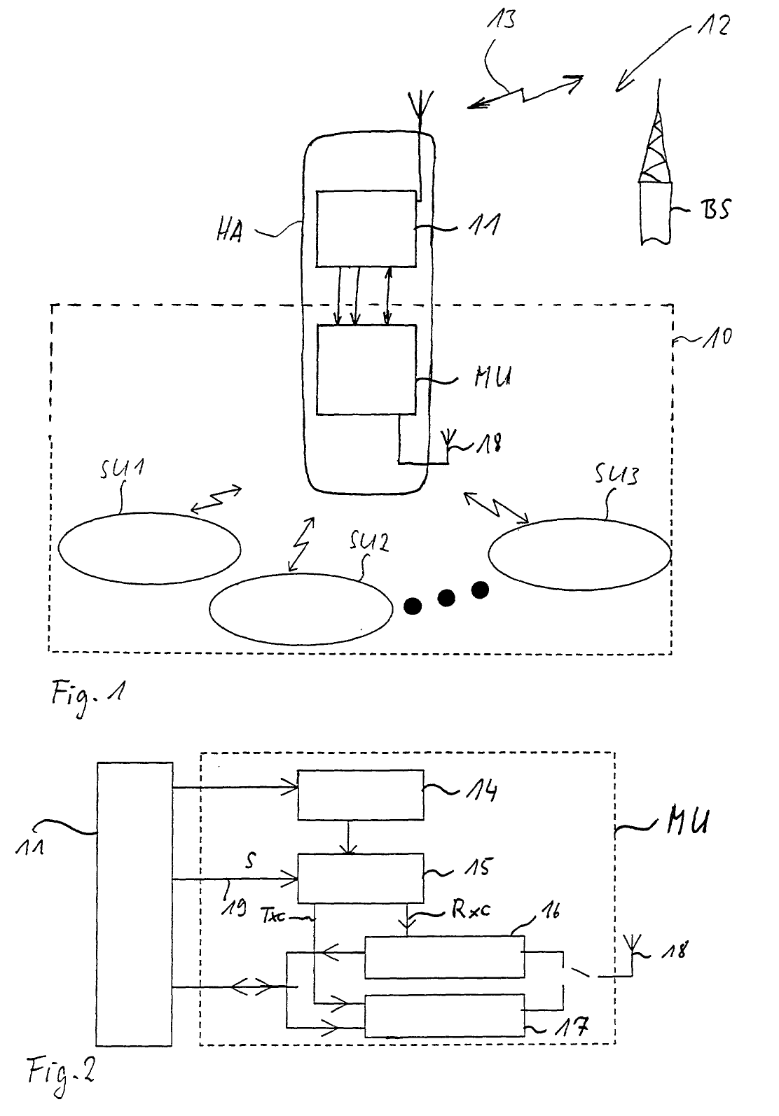

FIG. 2 shows a schematic block diagram of the design and the connection of the main unit of the radiocommunications system to the terminal of a reference system,

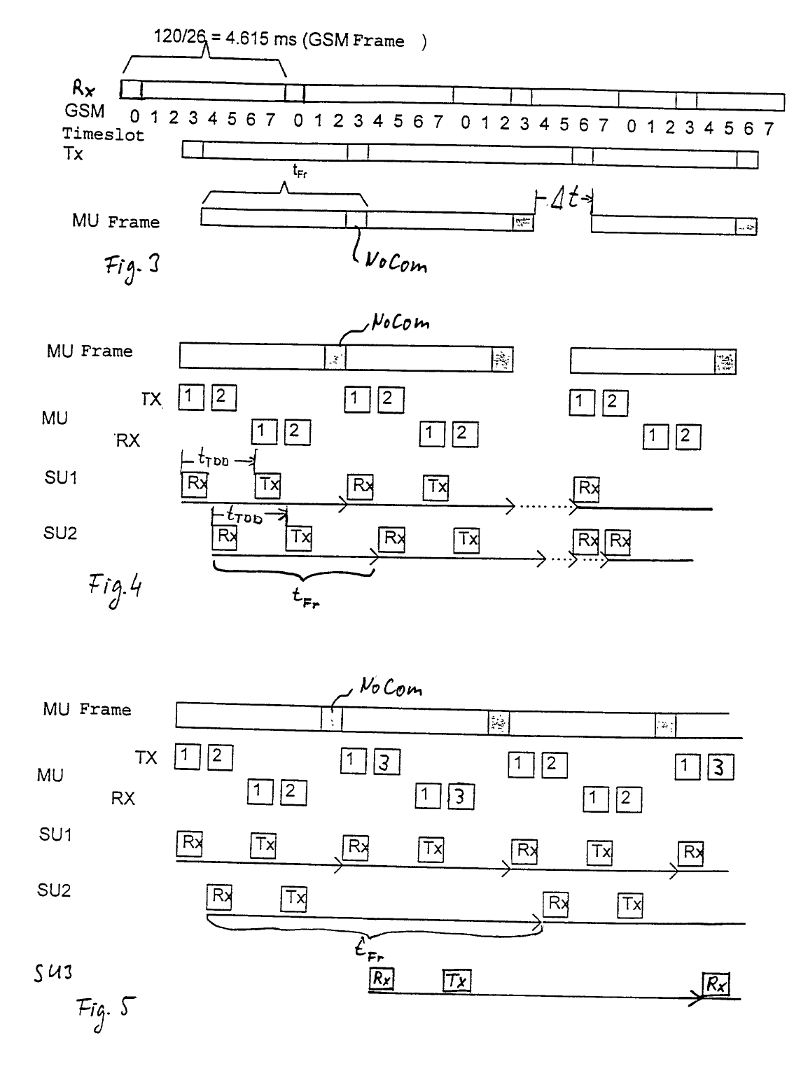

FIG. 3 shows a timing diagram to explain the frame structures of the reference system and of the local radiocommunications system,

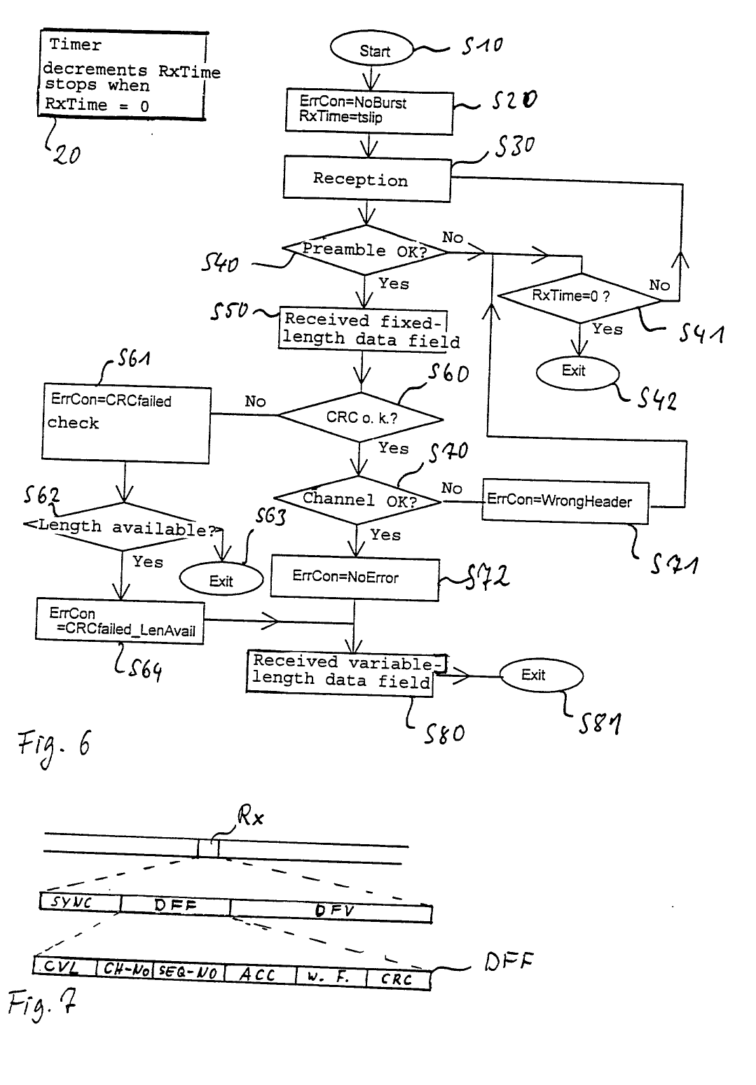

FIG. 4 shows a schematic timing diagram to explain how communication takes place within the radiocommunications system when a shift occurs in the transmission activities of the reference system,

FIG. 5 shows a timing diagram to explain how communication takes place with different frame times for the slave units in the local radiocommunications system,

FIG. 6 shows a flowchart for the receiving mode in a slave unit in the local radiocommunications system, and

FIG. 7 shows a schematic illustration of the structure of an information packet or burst.

Parts and method steps which correspond to one another have the same reference symbols in the various figures of the drawing.

The local radiocommunications system 10 which is illustrated purely schematically in FIG. 1 and whose main unit MU is arranged in the handset HA together with the terminal 11 of a reference system, for example, a cellular mobile radio system 12, may, for example as a slave unit SU, have an operating keypad which is separate from the handset HA, and as a further slave unit may have a loudspeaker/microphone unit, which is likewise separate from the handset HA. However, it is also feasible for a fax machine or a personal computer PC, a laptop or a notebook to interchange data as a slave unit via a radio interface with the main unit MU, so that no costly cables and plug connections are required. In this case, if the time-division multiplex mode is suitably designed, a large number of slave units SU can interchange data with the main unit MU at the same time, which would not be possible using a line connection, since a large number of corresponding plug connections would then have to be provided, which is not consistent with the continuous desire to reduce the size of the handsets HA.

The terminal 11 of the reference system, that is to say of the cellular mobile radio system 12, communicates with the base station BS via a channel 13, in which case all the activities are embedded in a frame structure. As is illustrated in FIG. 3, the frame time in a GSM frame, by way of example, is t_{Fr}=120/26 ms=4.615 ms. Each frame is in this case subdivided to a large number of timeslots, in order to provide a reserved time period within a frame for a specific connection for each downlink connection (the base station BS transmits, the terminal 11 receives) and for each uplink connection (the terminal 11 transmits, the base station BS receives). For example, the terminal 11 in each case switches to receive in the GSM timeslot 0, as is illustrated in the first line, denoted by Rx, in FIG. 3, while, first of all, it transmits in each case in the GSM timeslot 3.

The frame time t_{Fr} used by the reference system 12 is—as is illustrated in FIG. 2—transmitted from the terminal 11 to a configuration register 14. At the same time, the number of sleep frames which comprises a sleep interval is also transferred, that is to say the time between two successive receive bursts in the sleep mode. The configuration parameters, that is to say the frame time t_{Fr} and the number of sleep frames, are transmitted to a time control unit 15 which controls a receive path 16 via the line RxC, and controls a transmit path 17 via the line TxC. The receive path 16 passes data received by means of the antenna 18 on to the terminal 11, while data to be transmitted are passed via the transmit path 17.

In order to time the transmission mode and reception mode of the main unit MU such that it does not interfere with the transmission mode of the terminal 11 and, above all, is not interfered with by the latter, the terminal 11 always transmits a start signal S, at the end of a burst transmitted by it, via a line 19 to the time control unit 15, which then starts the frame time t_{Fr} in the main unit MU, as is illustrated in FIG. 3. At the start of the terminal's transmission mode, a stop signal for the activities of the main unit MU is likewise transmitted via the line 19 for the situation in which the activities in the main unit MU have not yet been completed. Thus, at the start of the transmission mode in the terminal 11, activities which are still taking place in the main unit MU are either forcibly ended or, at least, are designated as activities which have possibly not been carried out completely. When allocating individual sections of the MU frame as timeslots for the main unit MU to communicate with the slave units SU using the time-division multiplex mode, it is necessary to ensure that the last time period NoCom in an MU frame which coincides with the transmission timeslot of the terminal 11 in the reference system 12 is not used for communications activities in the local radiocommunications system.

If the timeslots allocated for communication with the base station change for the terminal 11 in the reference system 12, as is illustrated between the second and the third GSM frame in the first line in FIG. 3, then the current frame of the main unit MU ends after the frame time t_{Fr} has elapsed, while the next frame, that is to say the third frame in the last line in FIG. 3, does not start until after a time Δt, since the transmission timeslot Tx of the terminal 11 has changed, for example, from GSM timeslot 3 to GSM timeslot 6. Δt in this case corresponds to the time interval between the old and the new GSM transmission timeslot.

In this way, the timing of the MU frames in the main unit MU in the local radiocommunications system 10 can always be matched to the timebase of the reference system, such that all the activities in the main unit MU always take place at the same time relative to the activities of the reference system 12. Although the frame time t_{Fr} of the MU frame in the main unit MU is illustrated here as having the same length as the GSM frame, it is possible to use integer multiples or fractions of the frame time of the reference system for the frame time t_{Fr}.

As is indicated schematically in FIG. 4, the main unit MU communicates, for example, with two slave units SU1 and SU2 in such a manner that the slave unit SU1 is allocated a transmission timeslot TX1, and the slave unit SU2 is allocated a transmission timeslot TX2 of the main unit MU. After a specified response delay time t_{TDD} or transmission delay has elapsed, the first slave unit SU1 transmits, so that the main unit MU receives the burst from the first slave unit SU1 during the reception timeslot RX1. The second slave unit transmits after the same transmission delay time t_{TDD}has elapsed, so that the main unit MU receives the signal packet from the second slave unit SU2 during the reception timeslot RX2. In the process, it is necessary to ensure that each slave unit SU starts the respective frame time t_{Fr} allocated to it on reception of a burst from the main unit MU. One transmission delay time for all slave units SU is thus sufficient to ensure that the slave units SU which communicate with the main unit MU using the time duplex method do not interfere with one another.

If the local radiocommunications system 10 has slave units SU1, SU2, SU3 which have different data traffic levels, then, for example as is illustrated in FIG. 5, a frame time t_{Fr} can be defined for the first slave unit SU1, this being identical to the frame time of the MU frame in the main unit MU. In this case, by way of example, the frame times t_{Fr} provided for the two other slave units SU2 and SU3 are twice as long as the frame time t_{Fr} of the MU frame.

During the first frame, the main unit communicates, as described with reference to FIG. 4, with the slave units SU1 and SU2. During the second frame, data are interchanged with the slave unit SU1 in the same way as before, since the first transmission timeslot TX1 and the first reception timeslot RX1 are reserved for the first slave unit SU1. The second transmission timeslot TX2 and the second reception timeslot RX2 are allocated to the second slave unit SU2 in the first frame and, in the illustrated exemplary embodiment, in all the other odd-numbered frames, while they are reserved for the third slave unit SU3 during the second frame and all the subsequent even-numbered frames. In order in this case to ensure that the timing between the main unit MU and the slave units SU1, SU2, SU3 matches, each slave unit need have reported to it only its corresponding frame time t_{Fr}, t′_{Fr}, while the transmission delay time t_{TDD} remains the same for each slave unit SU.

Depending on the number of slave units and their respective data traffic levels, the lengths of the timeslots can also be varied in addition to or instead of the different frame times for the slave units. In this case, the timeslot duration expediently has a fixed relationship to the timebase in the main unit MU.

If a time slip Δt occurs in the reference system, that is to say, for example, the timeslot allocated to the terminal 11 changes, then the respective second frames in the slave unit SU1 and the slave unit SU2 in FIG. 4 end at a time at which the third frame has not yet started in the main unit MU. However, after the end of a frame, each slave unit SU in the local radiocommunications system 10 waits to receive a signal packet Rx intended for it. Each slave unit thus changes to a standby mode state and, on receipt of a burst, checks whether this burst is intended for it. As is illustrated in FIG. 4, the burst transmitted by the main unit MU after the time slip Δt for the first slave unit SU1 has ended is thus received by both the first and the second slave units SU1, SU2. In the process, the first slave unit SU1 uses appropriate information in the burst to identify the fact that this burst is intended for it, while the second slave unit SU2 determines in a corresponding manner that this burst is not intended for it. The first slave unit SU1 thus starts the corresponding frame, and is once again synchronized to the timing of the main unit MU. If the burst Rx for the second slave unit SU2 is transmitted as the next burst in the transmission timeslot TX2, only the second slave unit is now in the standby mode, and is then likewise once again synchronized to the timing of the main unit MU by reception of the burst Rx intended for it.

In order to prevent any slave unit SU being continuously in the standby mode, the standby mode is maintained only until a maximum time tₛₗᵢₚ defined for the time slip Δt has elapsed, after which the slave unit ends the standby mode.

The reception mode in a slave unit SU will now be explained with reference to FIG. 6. After a frame time t_{Fr} has elapsed, the reception mode is started in the step S10. An error identification variable ErrCon is then set, in the step S20, to a NoBurst value, which indicates that no burst or no signal packet has been received. In addition, the standby mode time RxTime in a timer 20 is set to tₛₗᵢₚ. The timer 20 in this case decrements the variable RxTime and stops when RxTime becomes equal to zero.

The slave unit S30 then changes to receive and then, in the step S40, checks whether the preamble of the signal packet is correct. If this is not the case, then a check is carried out in the step S41 to determine whether the standby mode time has elapsed, which is the case if the variable RxTime is equal to zero. If the standby mode time has not yet elapsed, then reception is continued in the step S30, while the standby mode is ended in the step S42 after the standby mode time has elapsed, in which case the error identification variable indicates that no signal packet has been received.

However, if the preamble of the signal packet is correct, then a fixed-length data field DFF (see FIG. 7) is received first of all in the step S50. After reception of this data field DFF has been completed, a transmission error identification code CRC is checked in the step S60 to confirm whether the data have been received without any errors. If this is the case, a check is carried out in the step S70 to determine whether the signal packet is intended for the receiving slave unit SU. This check in the step S70 can be checked, for example, using the channel number CH-NO allocated to the slave unit SU. If the signal packet is not intended for the receiving slave unit SU, then, in the step S71, the error identification variable ErrCon is set to a WrongHeader value which indicates that, although a burst has been received, the burst was not, however, intended for the receiving slave unit SU. A check is then carried out in the step S41 to determine whether the maximum standby mode time has already elapsed. If this is not the case, the normal reception mode is continued in the step S30. The reception of an incorrect signal packet described here in this case corresponds to the reception of the signal packet, explained with reference to FIG. 4, for the first slave unit SU1 by the second slave unit SU2.

If it is found in the step S70 not only that a burst or signal packet has been received without any errors but that it is also intended for the receiving slave unit SU, then the error code ErrCon is set in the step S72 to a NoError value which indicates that there were no errors in the reception. The variable-length data field DFV containing the wanted data is then received in the step S80, after which the reception routine is left, in the step S81.

However, if it is found in the step S60 that the transmission error identification code CRC is not correct, then, first of all, the error identification variable ErrCon is set in the step S61 to a corresponding value CRCfailed in order then to check a length code CVL for errors. A check is then carried out in the step S62 to determine whether the length of the variable-length data field DFV is available. If this is not the case, the reception routine is left in the step S63. However, if the length is available, then the error identification variable ErrCon is set in the step S64 to a value CRCfailed_LenAvail which indicates that, although the data in the fixed-length data field contain errors, the required information for receiving the variable-length data field DFV, namely the current length of this field, is, however, available, so that the variable-length data field can be received in the step S80.

If the transmission error identification code CRC indicates a transmission error in the fixed-length data field, then it is admittedly not possible to check whether the received signal packet is or is not allocated to the receiving slave unit SU. Since, however, it can be assumed that it is more probable that a transmission error has occurred than that an incorrect signal packet has been received, uniform data interchange can be maintained in this way. Even if, as is illustrated by way of example in the last line in FIG. 4, the receiving second slave unit (during reception of the signal packet for the first slave unit) accepts the receiving burst as its own signal packet as a result of an incorrect transmission error identification code CRC, then this error is corrected during the next reception in which the transmission error identification code CRC is correct, since the incorrect channel number is then identified in the step S70 and the unit waits for the correct signal packet by continuing the reception mode in the step S30.

As is illustrated purely schematically in FIG. 7, the downlink burst, which is transmitted with a low transmission power level, has a sufficiently long preamble SYNC which is used for synchronization of the receiving slave unit and which allows the slave unit to carry out a continuous search process during the standby mode time. This preamble SYNC can be shorter for an uplink burst, since a corresponding uplink burst is always transmitted and received after a fixed duplex or transmission delay time.

The preamble SYNC is then followed by the fixed-length data field DFF, which is followed by the variable-length data field DFV which contains the wanted information. However, in addition to the wanted data, secured data can also be provided therein, for example a further transmission error identification code CRC.

In the downlink connection, in addition to the transmission error identification code CRC, the fixed-length data field DFF contains, above all, the length used in the respective burst or signal packet as a coded length information item CVL, the channel number CH-NO, the sequence number SEQ-NO which represents an explicit counter for the respective frame as well as, for example, a field ACC for transmitting control information between the main unit and the slave unit, together with further fields as required. In addition to the variable length of the variable-length data field DFV, the coded variable length CVL contains an error-correcting code, so that the length can still be decoded, even if some of the bits are incorrect.

The use of a variable-length data field in the information packet allows both data streams with a constant data rate and data packets to be transmitted reliably with an energy consumption that is as low as possible.

The present invention thus provides a flexible frame structure which permits variable frame and timeslot lengths as well as a variable number of timeslots per frame. The transfer of the timebase of a reference system as its own timebase for the main unit in a local radiocommunications system, and the synchronization of the timebase to the transmission mode of the terminal in the reference system, result in the capability to change the frame structure in the local radiocommunications system largely freely without interactive interference occurring in the systems. In consequence, there is also no need to take any circuitry precautions to prevent mutual interference.

1. Method for controlling the transmission and reception activities of a local radiocommunications system having a main unit (MU) and at least one slave unit (SU) in which a timebase for communication with the slave unit or units (SU) is defined in the main unit (MU), and the frame time (t_{Fr}) defined on the basis of this timebase is reported to each slave unit (SU).

2. Method according to claim 1, characterized in that, in order to match the transmission and reception activities of the radiocommunications system (10) to a reference system (12), the timebase of the local radiocommunications system (10) is derived from the timebase of the reference system (12).

3. Method according to claim 2, characterized in that the main unit (MU) is allocated to a terminal (11) of the reference system (12), and in that the timebase of the main unit (MU) is correlated with the transmission activity of the terminal (11).

4. Method according to claim 2 or 3, characterized in that a frame time (t_{Fr}) of the reference system (12) is used as the timebase for the local radiocommunications system (10), and in that the frame time (t_{Fr}) for each slave unit (SU) is related to the timebase by an integer ratio.

5. Method according to one of the preceding claims, characterized in that the frame time (t_{Fr}) in each slave unit (SU) is in each case measured from the start of a received information packet.

6. Method according to one of the preceding claims, characterized in that, during normal communications operation, each slave unit (SU) respectively changes at the end of a frame to the standby mode.

7. Method according to claim 6, characterized in that each slave unit (SU) remains in the standby mode, either until it receives an information packet intended for it, or until a time (tₛₗᵢₚ) specified for the maximum duration of the standby mode has elapsed.

8. Method according to claim 7, characterized in that the time (tₛₗᵢₚ) which is specified for the maximum duration of the standby mode is defined as a function of the frame time (t_{Fr}) in the reference system (12).

9. Method according to one of the preceding claims, characterized in that an information item (CH-NO) is transmitted with each information packet which allows the information packet to be allocated to the slave unit (SU).

10. Method according to one of the preceding claims, characterized in that the reporting of the frame time (t_{Fr}), of the response time delay (t_{DD}) and of the maximum response duration is carried out by sending a message to all the associated slave units (SU) or by communication with each individual slave unit (SU).

11. Method according to one of the preceding claims, characterized in that, after completion of normal communications operation, a sleep mode is initiated, whose sleep interval corresponds to that of the terminal (11) in the reference system (12).

12. Method according to one of the preceding claims, characterized in that each information packet has a data field (DFF) of fixed length for control data and a data field (DFV) of variable length for user or wanted data, the length information (VL) for the variable-length data field being transmitted in the fixed-length data field (DFF).

13. Method according to claim 12, characterized in that the length information (VL) is protected by means of an error-correcting code which is transmitted in the fixed-length data field.

14. Method according to claim 12 or 13, characterized in that other fields in the fixed-length data field (DFF) are also protected by means of an error-correcting code which is transmitted in the fixed-length data field (DFF).
